(19) United States
(12) Patent Application Publication
(10) Pub. No.: US 2026/0258903 A1
(43) Pub. Date: Sep. 3, 2026

(54) MOUNTING DEVICE FOR AN EXTERIOR FIXTURE

(71) Applicant: Multi Mini Mount, Moab, UT (US)

(72) Inventors: Rory Paxman, Moab, UT (US); Courtney Atwood, Moab, UT (US)

(21) Appl. No.: 19/554,536

(22) Filed: Mar. 2, 2026

Related U.S. Application Data
(60) Provisional application No. 63/765,283, filed on Feb. 28, 2025.

(51) Int. Cl. F16M 13/02

(52) U.S. Cl. CPC F16M 13/022

(57) ABSTRACT

A mounting device for an exterior fixture includes a support assembly and a bracket assembly with a first bracket and a second bracket. The first bracket is coupled to the support assembly and the second bracket is pivotable with respect to the first bracket to set a pre-determined angle between the first bracket and the second bracket. The mounting device is adjustable between at least one configuration including a substantially horizontal configuration, a substantially vertical configuration, and an inclined configuration based on the angle set between the first bracket and the second bracket during installation of the exterior fixture. The mounting device is installable on an installation surface, and may engage a pre-installed shelf on the installation surface. The exterior fixture is coupled to the second bracket when the mounting device is in the at least one configuration after installation of the mounting device on the installation surface.

### CROSS-REFERENCE TO RELATED APPLICATION

The present application claims the benefit of priority under 35 U.S.C. § 119(e) to U.S. Provisional Patent Application No. 63/765,283, filed on Feb. 28, 2025, the entirety of which is incorporated herein by reference.

### FIELD OF THE DISCLOSURE

The disclosure relates to a mounting device for an exterior fixture and, in particular, is directed to a mounting device and a system and method for installing an air conditioning unit on different installation surfaces using different configurations of the mounting device.

### BACKGROUND

The background description includes information that may be useful in understanding the present inventive subject matter. It is not an admission that any of the information provided herein is prior art or relevant to the presently claimed disclosure, or that any publication specifically or implicitly referenced is prior art.

Air conditioning units or other exterior fixtures may be installed at a jobsite in a plurality of exterior locations of a residential or commercial structure. For example, the air conditioning units or other exterior fixtures may be installed on a ground surface (e.g., on a concrete surface, or the like) proximate to the structure, in a window of the structure, or on a roof of the structure. Determining where to install the air conditioning units or other exterior fixtures currently requires pre-planning prior to installation at the jobsite, as components specific to the location of installation also need to be acquired prior to installation. Altering the location of the air conditioning units or other exterior fixtures during installation may result in lost time on the jobsite, as different components that are specific to the new location of installation may need to be acquired. This may compound to further losses in other stages of a project at the jobsite, where one stage is the installation of the air conditioning units or other exterior fixtures.

### SUMMARY

As such, there exists a need for a mounting device for exterior fixtures that is able to be arranged in a plurality of configurations, where each configuration of the plurality of configurations is specific to the location of installation. The mounting device should be easily reconfigurable between the plurality of configurations, such that an installer can complete the reconfiguration while on the jobsite and without loss of time. This may be especially beneficial where the location of installation is left to the installer to determine in nearly real-time during the installation, as the installer does not have to procure and transport extra and non-used mounting devices for installation at any possible exterior location at the jobsite.

Embodiments of the present disclosure are directed to a mounting device for an air conditioning unit or other exterior fixture. In some configurations, the mounting device is able to support up to 1000 pounds per device. In some configurations, the mounting device is able to withstand winds up to 150 miles per hour.

The mounting device is able to be set up in a plurality of configurations without needing to modify the mounting device (e.g., add or remove components) as assembled, where each configuration can be installed on a ground surface (e.g., a concrete surface located proximal to an exterior of a structure), on a wall surface of the structure, or on a roof of the structure respectively. Embodiments of the present disclosure are directed to multiple mounting devices being used in a system, and additionally are directed to a method for installation of the mounting device (or multiple mounting devices in the system).

Embodiments of the present disclosure are directed to a mounting device with a support assembly and a bracket assembly. The support assembly includes one or more bases, each with a foot and a leg. The bracket assembly includes a first bracket that is coupled to the support assembly, and a second bracket that is pivotable with respect to the first bracket. The mounting device is adjustable for a plurality of configurations, including a substantially horizontal configuration (e.g., for substantially horizontal ground surfaces or roof surfaces of a structure, etc.), a substantially vertical configuration (e.g., for wall surfaces of the structure), and/or an inclined configuration (e.g., for inclined roof surfaces of the structure, inclined ground surfaces, etc.).

In embodiments, the bracket may be set at a pre-determined or selected angle relative to the first bracket, including approximately 0 degrees, approximately 90 degrees, and between approximately 0 degrees and approximately 90 degrees. An optional support member may secure the second bracket at the pre-determined or selected angle from the first bracket. For example, the first bracket may include a support member aperture that aligns with a support member aperture of the second bracket for an angle of approximately 90 degrees. By way of another example, the first bracket may include a support member aperture that aligns with a pitch aperture of the second bracket for an angle of between approximately 0 degrees and approximately 90 degrees. Further, the optional support member may be stored within the mounting device when the angle is approximately 0 degrees.

In embodiments, standoffs may be installed on the second bracket after the particular angle is set. The standoffs are installed within standoff apertures in a surface of a platform of the second bracket, where the surface is dependent on the configuration of installation and resultant angle between the first bracket and the second bracket.

A first aspect of the present disclosure is to provide a mounting device for an exterior fixture. The mounting device comprises a support assembly and a bracket assembly. The bracket assembly comprises a first bracket and a second bracket. The first bracket is coupled to the support assembly and the second bracket is pivotable with respect to the first bracket to set a pre-determined angle between the first bracket and the second bracket. The mounting device is selectively adjustable between at least one configuration including a substantially horizontal configuration, a substantially vertical configuration, and an inclined configuration based on the pre-determined angle set between the first bracket and the second bracket during installation of the exterior fixture. The mounting device is installable on an installation surface. The exterior fixture is coupled to the second bracket when the mounting device is in the selected configuration of the at least one configuration after installation of the mounting device on the installation surface.

The mounting device of the first aspect may include, optionally, that the support assembly comprises at least one base including a foot coupled to a first end of a leg. The first bracket is coupled to a second end the leg.

The mounting device of the first aspect may include one or more of the previous embodiments and, optionally, at least one standoff couplable to a respective standoff aperture within a surface of a platform of the second bracket. The exterior fixture is coupled to the mounting device via the at least one standoff.

The mounting device of the first aspect may include one or more of the previous embodiments and, optionally, that the surface is an exterior surface of the platform of the second bracket when the mounting device is in the substantially horizontal configuration.

The mounting device of the first aspect may include one or more of the previous embodiments and, optionally, that the surface is an interior surface of the platform of the second bracket when the mounting device is in the substantially vertical configuration.

The mounting device of the first aspect may include one or more of the previous embodiments and, optionally, that the surface is an exterior surface of the platform of the second bracket when the mounting device is in the inclined configuration.

The mounting device of the first aspect may include one or more of the previous embodiments and, optionally, a support bracket that couples to the first bracket and a second bracket, that the support bracket secures the first bracket and the second bracket at the pre-determined angle.

The mounting device of the first aspect may include one or more of the previous embodiments and, optionally, that the support bracket is housed within a cavity defined between the first bracket and the second bracket when the mounting device is in the substantially horizontal configuration.

The mounting device of the first aspect may include one or more of the previous embodiments and, optionally, that a fastener for the support bracket is inserted within connecting apertures of the first bracket and the second bracket to prevent the second bracket from pivoting relative to the first bracket when the mounting device is in the substantially horizontal configuration.

The mounting device of the first aspect may include one or more of the previous embodiments and, optionally, that the support bracket engages a first support member aperture on the first bracket and a second support member aperture on the second bracket when the mounting device is in the substantially vertical configuration.

The mounting device of the first aspect may include one or more of the previous embodiments and, optionally, that the support bracket engages a support member aperture on the first bracket and a pitch aperture on the second bracket when the mounting device is in the inclined configuration. The pitch aperture is one of a plurality of pitch apertures. Each pitch aperture of the plurality of pitch apertures corresponds to a particular roof pitch.

A second aspect of the present disclosure is to provide a mounting system for an exterior fixture. The mounting system includes at least one mounting device for the exterior fixture. The at least one mounting device includes a support assembly and a bracket assembly. The bracket assembly includes a first bracket and a second bracket. The first bracket is coupled to the support assembly and the second bracket is pivotable with respect to the first bracket to set a pre-determined angle between the first bracket and the second bracket. The at least one mounting device is selectively adjustable between at least one configuration including a substantially horizontal configuration, a substantially vertical configuration, and an inclined configuration based on the pre-determined angle set between the first bracket and the second bracket during installation of the exterior fixture. The at least one mounting device is installable on an installation surface. The exterior fixture is coupled to the second bracket when the at least one mounting device is in the selected configuration of the at least one configuration after installation of the at least one mounting device on the installation surface.

The mounting system of the second aspect may include, optionally, at least one standoff couplable to a respective standoff aperture within a surface of a platform of the second bracket. The exterior fixture is coupled to the at least one mounting device via the at least one standoff.

The mounting system of the second aspect may include one or more of the previous embodiments and, optionally, the at least one mounting device further including a support bracket that couples to the first bracket and a second bracket. The support bracket secures the first bracket and the second bracket at the pre-determined angle.

The mounting system of the second aspect may include one or more of the previous embodiments and, optionally, a shelf installable on the installation surface prior to the installation of the at least one mounting device. The at least one mounting device is able to engage the shelf during installation of the at least one mounting device.

A third aspect of the present disclosure is to provide a method for installing an exterior fixture. The method may include, but is not limited to, installing a mounting device on an installation surface, the mounting device including a support assembly and a bracket assembly, the bracket assembly including a first bracket and a second bracket. The first bracket is coupled to the support assembly and the second bracket is pivotable with respect to the first bracket to set an angle between the first bracket and the second bracket. The method may include, but is not limited to, setting the mounting device to a pre-determined angle for installation of an exterior fixture. The mounting device is selectively adjustable between at least one configuration including a substantially horizontal configuration, a substantially vertical configuration, and an inclined configuration based on the pre-determined angle set between the first bracket and the second bracket during installation of the exterior fixture. The method may include, but is not limited to, installing an exterior fixture on the mounting device. The exterior fixture is coupled to the second bracket when the mounting device is in the selected configuration of the at least one configuration after installation of the mounting device on the installation surface.

The method of the third aspect may include, optionally, installing at least one standoff on the mounting device prior to installation of the exterior fixture on the mounting device. The exterior fixture is coupled to the mounting device via the at least one standoff.

The method of the third aspect may include one or more of the previous embodiments and, optionally, installing a second mounting device on the installation surface. The second mounting devices includes a second support assembly, and a second bracket assembly with a third bracket and a fourth bracket. The third bracket is coupled to the second support assembly and the fourth bracket is pivotable with respect to the first bracket to set an angle between the third bracket and the fourth bracket. The method may include, but is not limited to, setting the second mounting device to a second pre-determined angle for installation of the exterior fixture. The second mounting device is selectively adjustable between at least one configuration including a substantially horizontal configuration, a substantially vertical configuration, and an inclined configuration based on the second pre-determined angle set between the third bracket and the fourth bracket during installation of the exterior fixture. The method may include, but is not limited to, installing the exterior fixture on the second mounting device. The exterior fixture is coupled to the fourth bracket when the second mounting device is in the selected configuration of the at least one configuration after installation of the second mounting device on the installation surface.

The method of the third aspect may include one or more of the previous embodiments and, optionally, installing at least one standoff on the second mounting device prior to installation of the exterior fixture on the mounting device. The exterior fixture is coupled to the second mounting device via the at least one standoff.

The method of the third aspect may include one or more of the previous embodiments and, optionally, the mounting device further comprising a support bracket that couples to the first bracket and a second bracket. The support bracket secures the first bracket and the second bracket at the pre-determined angle.

The method of the third aspect may include one or more of the previous embodiments and, optionally, installing a shelf on the installation surface prior to installing the mounting device. The mounting device is able to engage the shelf during installation of the mounting device.

The phrases “at least one,” “one or more,” and “and/or,” as used herein, are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together. When each one of A, B, and C in the above expressions refers to an element, such as X, Y, and Z, or class of elements, such as X₁-Xₙ, Y₁-Yₘ, and Z₁-Zₒ, the phrase is intended to refer to a single element selected from X, Y, and Z, a combination of elements selected from the same class (e.g., X₁ and X₂) as well as a combination of elements selected from two or more classes (e.g., Y₁ and Zₒ).

Unless otherwise indicated, all numbers expressing quantities, dimensions, conditions, and so forth used in the specification and claims are to be understood as being modified in all instances by the term “about.”

As used herein, unless otherwise specified, the terms “about,” “approximately,” etc., when used in relation to numerical limitations or ranges, mean that the recited limitation or range may vary by up to 10%. By way of non-limiting example, “about 750” can mean as little as 675 or as much as 825, or any value therebetween. When used in relation to ratios or relationships between two or more numerical limitations or ranges, the terms “about,” “approximately,” etc. mean that each of the limitations or ranges may vary by up to 10%; by way of non-limiting example, a statement that two quantities are “about equal” or “approximately equal” can mean that a ratio between the two quantities is as little as 0.9:1.1 or as much as 1.1:0.9 (or any value therebetween), and a statement that a four-way ratio is “about 5:3:1:1” can mean that the first number in the ratio can be any value of at least 4.5 and no more than 5.5, the second number in the ratio can be any value of at least 2.7 and no more than 3.3, and so on.

The use of “substantially” in the present disclosure, when referring to a measurable quantity (e.g., a diameter or other distance) and used for purposes of comparison, is intended to mean within 5% of the comparative quantity. The terms “substantially similar to,” “substantially the same as,” and “substantially equal to,” as used herein, should be interpreted as if explicitly reciting and encompassing the special case in which the items of comparison are “similar to,” “the same as” and “equal to,” respectively.

The term “a” or “an” entity, as used herein, refers to one or more of that entity. As such, the terms “a” (or “an”), “one or more” and “at least one” can be used interchangeably herein.

The use of “including,” “comprising,” or “having” and variations thereof herein is meant to encompass the items listed thereafter and equivalents thereof as well as additional items. Accordingly, the terms “including,” “comprising,” or “having” and variations thereof can be used interchangeably herein. The use of “engaged with” and variations thereof herein is meant to encompass any direct or indirect connections between components.

It should be understood that every maximum numerical limitation given throughout this disclosure is deemed to include each and every lower numerical limitation as an alternative, as if such lower numerical limitations were expressly written herein. Every minimum numerical limitation given throughout this disclosure is deemed to include each and every higher numerical limitation as an alternative, as if such higher numerical limitations were expressly written herein. Every numerical range given throughout this disclosure is deemed to include each and every narrower numerical range that falls within such broader numerical range, as if such narrower numerical ranges were all expressly written herein. By way of example, the phrase from about 2 to about 4 includes the whole number and/or integer ranges from about 2 to about 3, from about 3 to about 4 and each possible range based on real (e.g., irrational and/or rational) numbers, such as from about 2.1 to about 4.9, from about 2.1 to about 3.4, and so on.

It shall be understood that the term “means” as used herein shall be given its broadest possible interpretation in accordance with 35 U.S.C. § 112(f). Accordingly, a claim incorporating the term “means” shall cover all structures, materials, or acts set forth herein, and all of the equivalents thereof. Further, the structures, materials, or acts and the equivalents thereof shall include all those described in the summary, brief description of the drawings, detailed description, abstract, and claims themselves.

All external references are hereby incorporated by reference in their entirety whether explicitly stated or not.

These and other advantages will be apparent from the disclosure contained herein. The above-described embodiments, objectives, and configurations are neither complete nor exhaustive. It is intended neither to identify key or critical elements of the disclosure nor to delineate the scope of the disclosure but to present selected concepts of the disclosure in a simplified form as an introduction to the more detailed description presented below. The Summary is neither intended nor should it be construed as being representative of the full extent and scope of the present disclosure. Moreover, references made herein to “the present disclosure,” or aspects thereof should be understood to mean certain embodiments of the present disclosure and should not necessarily be construed as limiting all embodiments to a particular description. The present disclosure is set forth in various levels of detail in the Summary as well as in the attached drawings and the Detailed Description and no limitation as to the scope of the present disclosure is intended by either the inclusion or non-inclusion of elements, components, etc. in this Summary. Additional aspects of the present disclosure will become more readily apparent from the Detailed Description, particularly when taken together with the drawings.

It is to be appreciated that any embodiment, feature, or aspect described herein can be claimed in combination with any other embodiment(s), feature(s), or aspect(s) as described herein, regardless of whether the features or aspects come from the same described embodiment. For example, any one or more aspects described herein can be combined with any other one or more aspects described herein. In addition, any one or more features described herein can be combined with any other one or more features described herein. Further, any one or more embodiments described herein can be combined with any other one or more embodiments described herein.

### BRIEF DESCRIPTION OF THE DRAWINGS

Those of skill in the art will recognize that the following description is merely illustrative of the principles of the disclosure, which may be applied in various ways to provide many different alternative embodiments. This description is made for illustrating the general principles of the teachings of this disclosure and is not meant to limit the inventive concepts disclosed herein.

The accompanying drawings, which are incorporated in and constitute a part of the specification, illustrate embodiments and together with the general description of the disclosure given above and the detailed description of the drawings given below, serve to explain the principles of the disclosure.

FIG. 1A illustrates a perspective view of a mounting device for an exterior fixture in a substantially horizontal mount configuration, in accordance with one or more embodiments of the present disclosure;

FIG. 1B illustrates a perspective view of the mounting device of FIG. 1A in a substantially vertical mount configuration;

FIG. 1C illustrates a front plan view of the mounting device of FIG. 1A in an angled or inclined mount configuration and at a first angle;

FIG. 1D illustrates a front plan view of the mounting device of FIG. 1C in the angled inclined mount configuration and at a second angle;

FIG. 2A illustrates a front elevation view of the mounting device of FIG. 1A;

FIG. 2B illustrates an end elevation view of the mounting device of FIG. 2A;

FIG. 2C illustrates a first top plan view of the mounting device of FIG. 2A;

FIG. 2D illustrates a second top plan view of the mounting device of FIG. 2A;

FIG. 3A is a perspective view of a mounting system including mounting devices in the substantially horizontal mount configuration of FIG. 1A, in accordance with one or more embodiments of the present disclosure;

FIG. 3B is a perspective view of the mounting system of FIG. 3A with a first exterior fixture;

FIG. 3C is a perspective view of the mounting system of FIG. 3A with a second exterior fixture;

FIG. 4A is a perspective view of a mounting system including mounting devices in the substantially vertical mount configuration of FIG. 1B, in accordance with one or more embodiments of the present disclosure;

FIG. 4B is a perspective view of the mounting system of FIG. 4A with an exterior fixture;

FIG. 4C is a perspective view of the mounting system of FIG. 4A with a shelf;

FIG. 4D is a perspective view of the mounting system of FIG. 4C with the shelf and the exterior fixture;

FIG. 5A is a perspective view of a mounting system including mounting devices in the angled or inclined mount configuration of FIG. 1C with an exterior fixture;

FIG. 5B is a perspective view of the mounting system of FIG. 5A with an exterior fixture; and

FIG. 6 illustrates a flow diagram of a method or process for the operation and use of the mounting device of FIG. 1A in a mounting system of FIG. 3A, 4A, or 5A, in accordance with one or more embodiments of the present disclosure.

It should be understood that the drawings are not necessarily to scale, and various dimensions may be altered. In certain instances, details that are not necessary for an understanding of the disclosure or that render other details difficult to perceive may have been omitted. It should be understood, of course, that the disclosure is not necessarily limited to the particular embodiments illustrated herein.

### REFERENCE NUMBER COMPONENT

100 Mounting Device
102 Support Assembly
104, 104A, 104B Base
106 Aperture in Base
108, 108A, 108B Foot
110, 110A, 110B First Surface of Foot
112, 112A, 112B Second Surface of Foot
114, 114A, 114B Legs
116 First End of Leg
118 Second End of Leg
120 Bracket Assembly
122 First Bracket
124 Second Bracket
126 Sidewalls of First Bracket
128 Platform of First Bracket
130 Channel of First Bracket
132 First Surface of Platform of First Bracket
134 Second Surface of Platform of First Bracket
136 Sidewalls of Second Bracket
138 Platform of Second Bracket
140 Channel of Second Bracket
142 First Surface of Platform of Second Bracket
144 Second Surface of Platform of Second Bracket
146 Cavity
148 First End of First Bracket
150 Second End of First Bracket
152 Connecting Apertures of First Bracket
154 Pivot Apertures of First Bracket
156 First End of Second Bracket
158 Second End of Second Bracket
160 Connecting Apertures of Second Bracket
161 Fastener for Connecting Apertures
162 Pivot Apertures of Second Bracket
163 Fastener for Connecting Apertures
164 Support Member Apertures of First Bracket
166 Support Member Apertures of Second Bracket
168, 168A Pitch Apertures of Second Bracket
168B, 168C Pitch Apertures of Second Bracket
168D, 168E, 168F Pitch Apertures of Second Bracket
170 Support Member
172 First End of Support Member
174 Second End of Support Member
176 Standoff Aperture
178 Standoff
180 Pitch Setting
182 Affixing Aperture
200 First End of Bracket Assembly
202 Second End of Bracket Assembly
300 Mounting System
302 Installation Surface
303 Structure
304 Exterior Fixture
306 Feet of Exterior Fixture
308 Housing of Exterior Fixture
400 Mounting System
402 Installation Surface
403 Structure
404 Exterior Fixture
406A, 406B Feet of Exterior Fixture
408 Housing of Exterior Fixture
410 Shelf
411 Plate
412 Apertures
414 Channel
416 Tab
500 Mounting System
502 Installation Surface
503 Structure
504 Exterior Fixture
506A, 506B Feet of Exterior Fixture
508 Housing of Exterior Fixture
600 Process Flow Diagram
602 Install a Shelf
604 Install a Mounting Device
606 Set an Angle for the Mounting Device
608 Install Standoffs on the Mounting Device
610 Install Additional Mounting Devices
612 Install an Exterior Fixture on the Mounting Device(s)
A Angle between the First and Second Brackets
B Angle between the Support Member and the First Bracket
C Angle between the Support Member and the Second Bracket
D1 Distance between the Bases
D2 Distance between the Legs
D3 Maximum Distance between Standoff Apertures
D4 Minimum Distance between Standoff Apertures
H Height of the Legs
L1 Length of the Bracket Assembly
L2 Total Length of the Mounting Device
R Diameter of the Standoffs
W1 Width of the Second Bracket
W2 Width of the First Bracket
W3 Width of the Feet

### DETAILED DESCRIPTION

Although the following text sets forth a detailed description of numerous different embodiments, it should be understood that the legal scope of the description is defined by the words of the claims set forth at the end of this disclosure. The Detailed Description is to be construed as exemplary only and does not describe every possible embodiment since describing every possible embodiment of the mounting device for an exterior fixture would be impractical, if not impossible. Numerous alternative embodiments could be implemented, using either current technology or technology developed after the filing date of this patent, which would still fall within the scope of the claims. Additionally, any combination of features shown in the various figures can be used to create additional embodiments of the present disclosure. Thus, dimensions, aspects, and features of one embodiment of the mounting device for an exterior fixture can be combined with dimensions, aspects, and features of another embodiment of the mounting device for an exterior fixture to create the claimed embodiment.

In general, embodiments of the present disclosure are directed to a mounting device for an exterior fixture (e.g., such as an air conditioning unit, or the like). The mounting device is able to be set up in a plurality of configurations without needing to modify the mounting device (e.g., add or remove components) as assembled, where each configuration can be installed on a ground surface (e.g., a concrete surface located proximal to an exterior of a structure), on a wall surface of the structure, or on a roof of the structure respectively. Embodiments of the present disclosure are directed to multiple mounting devices being used in a system, and additionally are directed to a method for installation of the mounting device (or multiple mounting devices in the system).

Embodiments of the present disclosure are also directed to the mounting device including a support assembly and a bracket assembly. The support assembly includes one or more bases, each with a foot and a leg. The bracket assembly includes a first bracket that is coupled to the support assembly, and a second bracket that is pivotable with respect to the first bracket. The mounting device is adjustable for a plurality of configurations, including a substantially horizontal configuration (e.g., for substantially horizontal ground surfaces or roof surfaces of a structure, etc.), a substantially vertical configuration (e.g., for wall surfaces of the structure), and/or an inclined configuration (e.g., for inclined roof surfaces of the structure, inclined ground surfaces, etc.). Embodiments of the present disclosure are directed to an optional support member for setting the pre-determined angle, and/or standoffs to raise and secure the exterior fixture to the second bracket.

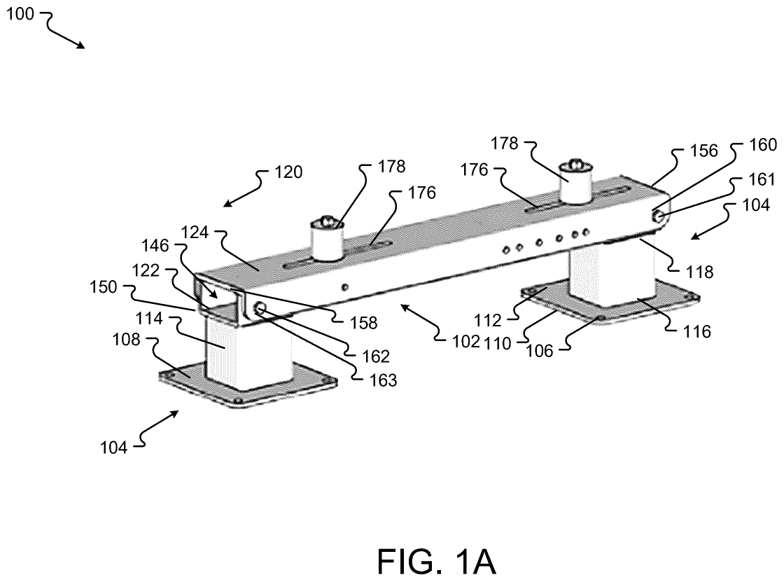

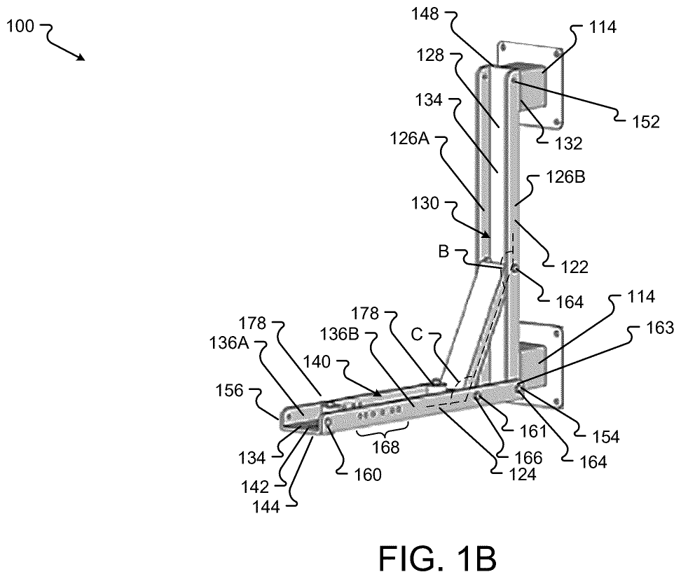

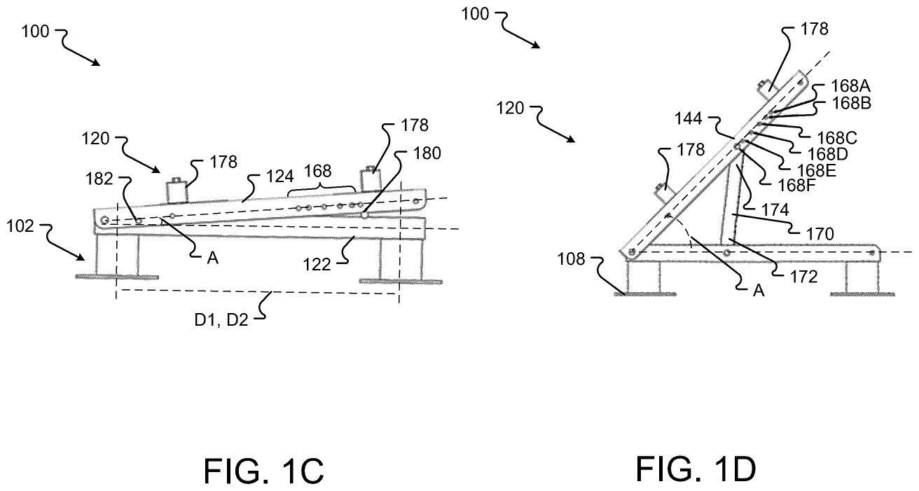

FIGS. 1A-1D in general illustrate a mounting device 100, according to one or more embodiments of the present disclosure. As illustrated in FIGS. 1A-1D, the mounting device 100 may be arranged in different mounting configurations, to be installed on or proximate to an exterior of a structure (e.g., a commercial structure or a residential structure) for installation of an exterior fixture such as an air conditioning unit, or the like.

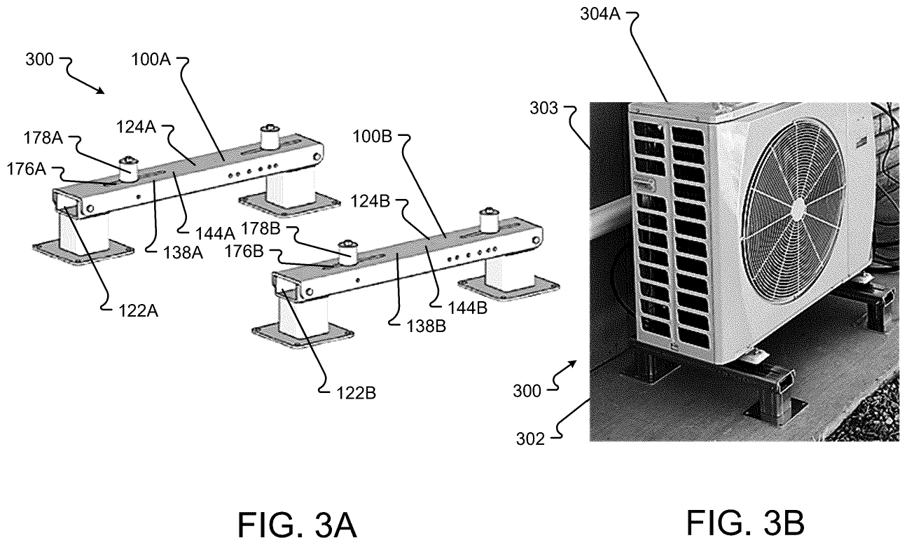

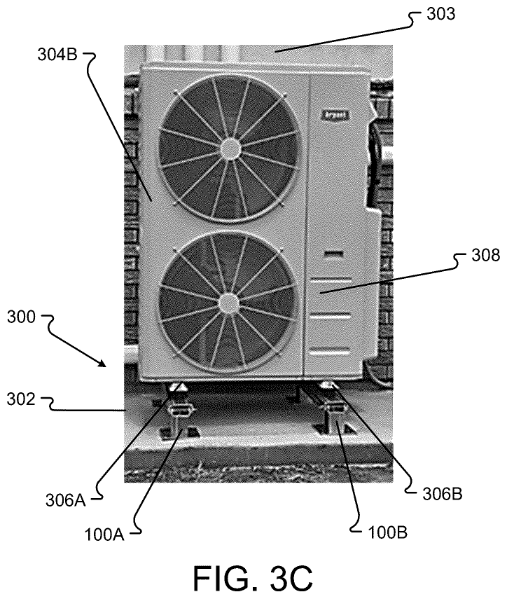

For example, as illustrated in FIG. 1A, the mounting device 100 may be configured as a substantially horizontal mount to be installed on an installation surface that is a substantially horizontal surface. For example, the substantially horizontal surface may be a substantially horizontal and planar ground surface, or another substantially planar surface that is substantially parallel to the substantially horizontal and planar ground surface (e.g., a concrete surface; a raised concrete, wood, plastic, or metal structure; or the like). It is noted that FIGS. 3A-3C also illustrate the mounting device 100 in the ground mount configuration.

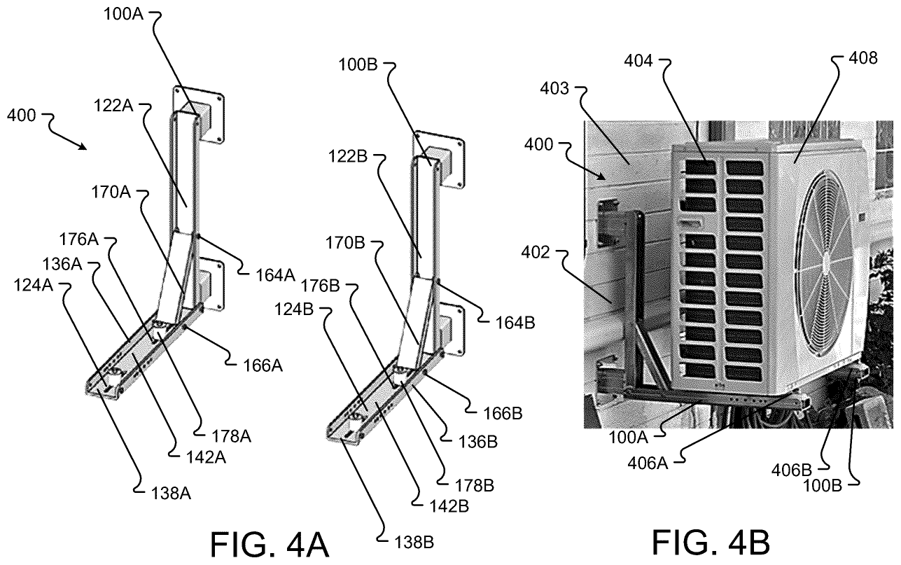

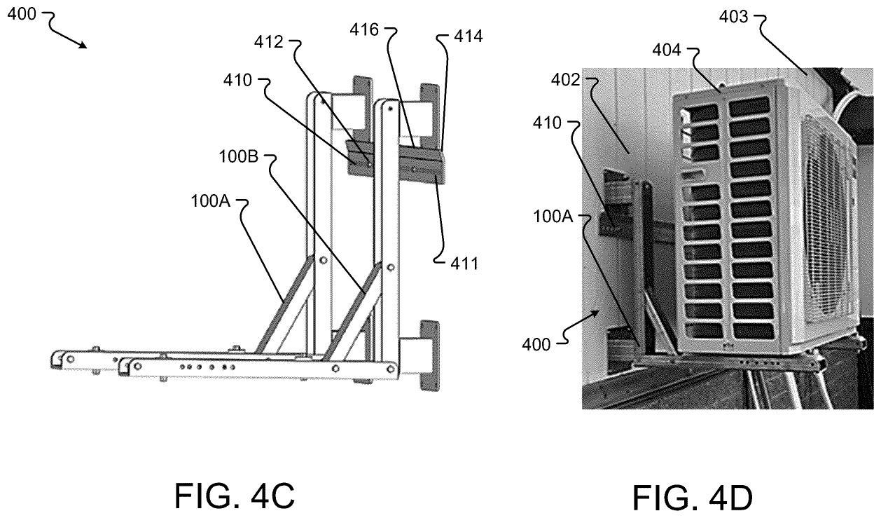

By way of another example, as illustrated in FIG. 1B, the mounting device 100 may be configured as a substantially vertical mount to be installed on an installation surface that is a substantially vertical surface. For example, the substantially vertical surface may be a substantially vertical and planar sidewall, or another exterior surface of the structure (or proximate to the structure, like a standalone wall) that is substantially perpendicular to a substantially horizontal ground surface. It is noted that FIGS. 4A-4D also illustrate the mounting device 100 in the substantially vertical or sidewall configuration with or without a shelf, as described in detail further herein.

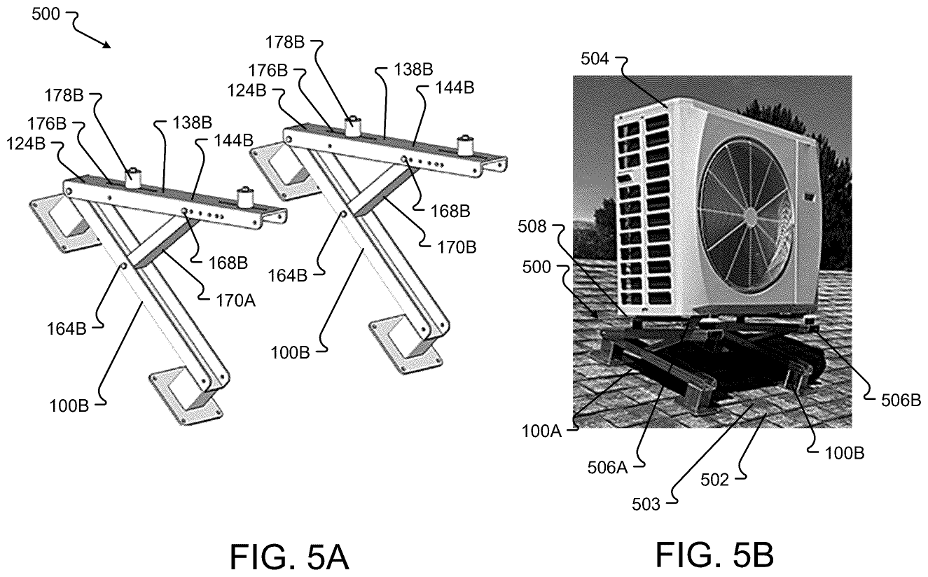

By way of another example, as illustrated in FIG. 1C-1D, the mounting device 100 may be configured to be installed on an installation surface that is angled from the substantially horizontal ground surface, such as an inclined roof of the structure. It is noted that FIGS. 5A-5B also illustrate the mounting device 100 in the inclined configuration.

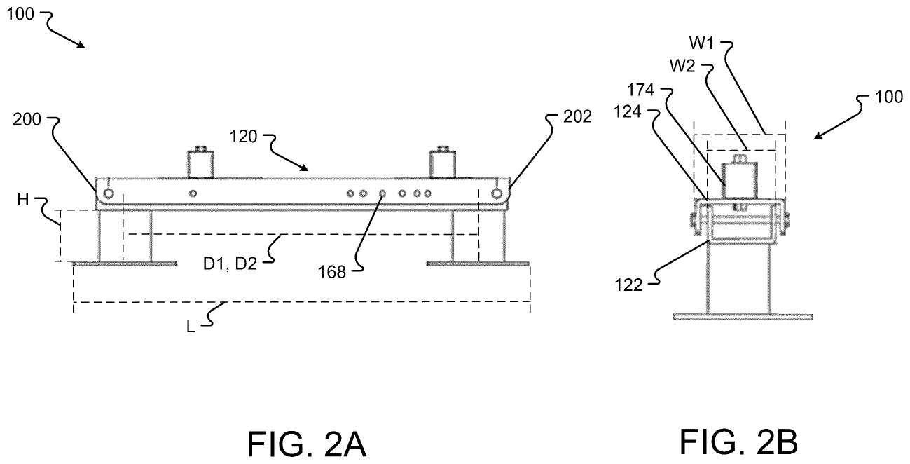

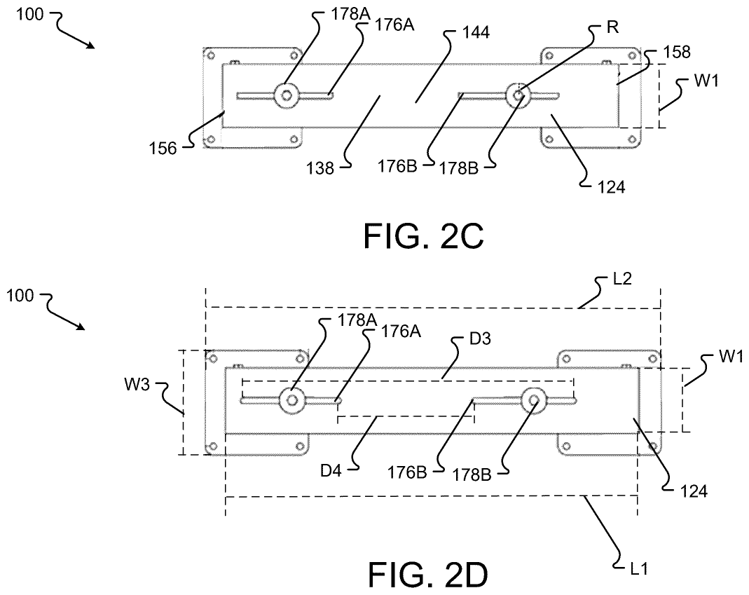

Referring generally to FIGS. 1A-1D and 2A-2D, in embodiments the mounting device 100 includes a support assembly 102 including one or more bases 104. For example, the support assembly 102 may include two or more bases 104. For instance, the two or more bases 104 may be evenly spaced along a length of the mounting device 100, or may be unevenly spaced, as may be necessary or desired to couple to the installation surface. However, it is contemplated that the mounting device 100 may only include a single base 104, such as where the mounting device 100 has a center of gravity over the base 104 or where a first end of the mounting device 100 has a base 104 and a second end of the mounting device 100 is coupled to another component on the structure, without departing from the scope of the present disclosure.

The base 104 includes one or more apertures 106 to secure the base to the installation surface. The base 104 includes one or more feet 108, where each foot 108 has a first surface 110 and a second surface 112. For example, the one or more apertures 106 may be within a respective foot 108, including passing through the first surface 110 and the second surface 112 to receive fasteners or a component of an interlocking assembly. In some non-limiting examples, the first surface 110 is positioned against the installation surface when the mounting device 100 is installed on the installation surface.

The base 104 includes one or more legs 114, where each leg 114 includes a first end 116 and a second end 118. For example, the first end 116 of a respective leg 114 may be coupled to the second surface 112 of a respective foot 108. It is noted that a respective first end 116 of each leg 114 may be affixed to the second surface 112 of a respective foot 108 via one or more joining processes (e.g., welding, or the like), via one or more fasteners, or via an adhesive when fabricating a particular base 104. It is noted, however, that each leg 114 may be integrally formed with a respective foot 108 during manufacturing (e.g., via one or more processes to fabricate the leg 114 and the foot 108 from a single piece of fabrication stock or material) when fabricating a particular base 104, without departing from the scope of the present disclosure.

In one non-limiting example, the mounting device 100 includes two bases 104A, 104B with respective feet 108A, 108B and legs 114A, 114B, where each foot 108A, 108B is connected to the respective leg 114A, 1146B. In this non-limiting example, spacing between the legs 114A, 114B may be spaced a distance D1 as measured from a respective center of the bases 104A, 104B. In addition, the legs 114A and 114B may be spaced a distance D2 from a center of gravity of the legs 114A, 114B. In the present embodiment, the distance D1 and distance D2 are approximately equal. It is appreciated that in other embodiments, however, the distances D1 and D2 can be different without departing from the scope of the present disclosure.

In another non-limiting example, the feet 108 are two rectangular plates (e.g., a square having four sides with a substantially equal length, or other rectangle). In another non-limiting example, the feet 108 each include four apertures 106. In some instances, the four apertures are arranged at or proximate to the four corners of the rectangular feet 108. The one or more feet 108 may also be constructed with any known two-dimension cross-section including 2, 3, . . . up to an N number of sides such as, but not limited to, a rectangle, a circle, a cross, and the like.

In another non-limiting example, the one or more legs 114 are rectangular prisms including a cross-section that is rectangular (e.g., a square with equal length and width, or other rectangle), and a height H. In some instances, the length and/or width of the cross-section of the legs 114 is smaller than the length of the sides of the feet 108. It is noted, however, that the length, width, and height of the one or more legs 114 may vary, without departing from the scope of the present disclosure. For instance, the legs 114 may vary in height to accommodate a slope of the ground surface (e.g., when not substantially horizontal) or a pitch angle of the roof surface. In addition, it is noted that the one or more legs 114 may have a cross-section including 2, 3, . . . up to an N number of sides in other shapes such as, but not limited to, a rectangular, a circle, a cross, and the like without departing from the scope of the present disclosure. Further, it is noted that the one or more legs 114 may be shaped like any known three-dimensional volume such as, but not limited to, a cube, a cylinder, a triangular prism, and the like without departing from the scope of the present disclosure.

In embodiments, the one or more bases 104 are coupled to a bracket assembly 120. The bracket assembly 120 is able to couple to an exterior fixture (e.g., such as an air conditioning unit, or the like) as described in detail further herein to secure the exterior fixture to the installation surface.

The bracket assembly 120 includes a first bracket 122. The first bracket 122 may be fabricated with any known three-dimensional volume such as, but not limited to, a rectangular prism, a cylinder, a triangular prism, and the like with any known axial cross-section (e.g., rectangle, circle, and the like) without departing from the scope of the present disclosure.

In one non-limiting example, the mounting device 100 the first bracket 122 is attached to the support assembly 102 by attaching to a respective leg 114 of each base 104. For example, the first bracket 122 may be affixed to the first end 116 of the legs 114 via one or more joining processes (e.g., welding, or the like), via one or more fasteners, or via an adhesive. It is noted, however, that the first bracket 122 may be integrally formed with the legs 114 during manufacturing (e.g., via one or more processes to fabricate the leg 114 and the first bracket 122 from a single piece of fabrication stock or material), without departing from the scope of the present disclosure.

The bracket assembly 120 includes a second bracket 124. The second bracket 124 may be fabricated with any known three-dimensional volume such as, but not limited to, a rectangular prism, a cylinder, a triangular prism, and the like with any known axial cross-section (e.g., rectangle, circle, and the like) without departing from the scope of the present disclosure. It should be understood that the first bracket 122 and the second bracket 124 may be, but not limited to being, fabricated as a substantially same shape or size.

In some embodiments, the first bracket 122 is set at a particular unchanging angle to the installation surface by being affixed to the support assembly 102, while the second bracket 124 may be adjustable to an angle A relative to the first bracket 122 and/or to the installation surface. For example, the angle A may range from approximately 0 degrees to approximately 180 degrees. In some instances, the angle A may range from approximately 0 degrees to approximately 90 degrees. It is noted that the angle A may be one or more preset angles that define roof pitches, as described in detail further herein.

In embodiments, the first bracket 122 and the second bracket 124 each have a U-Shape (e.g., with a U-shaped cross-section). In some embodiments, a width of the sidewalls 136 of the second bracket 124 is greater than the width of the sidewalls 126 of the first bracket 122, such that the second bracket 124 envelops the first bracket 122. In other embodiments, the width of the sidewalls 126 is greater than the width of the sidewalls 136, such that the second bracket 124 nests within the first bracket 122, without departing from the scope of the present disclosure.

In addition, it is contemplated that the first bracket 122 and/or the second bracket 124 is not limited to the U-shape, but may have any cross-section shape that allows for the compact folding of the bracket assembly 120 as described in detail further herein, without departing from the scope of the present disclosure. For example, the first bracket 122 may have a U-shape cross-section, while the second bracket 124 may have a rectangular cross-section. By way of another example, the first bracket 122 and/or the second bracket 124 may only include a respective platform 128, 138 without sidewalls 126, 136. Here, flanges or tabs may be used for the connecting and pivot apertures and described in detail further herein, in place of the absent sidewalls. In other embodiments, the first and second brackets 122 and 124 are each constructed as a plate (e.g., with optional flanges or tabs). In other embodiments, the first and second brackets 122 and 124 are each constructed as a rectangular prism with a rectangular cross-section.

In one non-limiting example, the first bracket 122 has sidewalls 126A and 126B coupled together by (or integrally formed with) a platform 128. The platform 128 and the sidewalls 126A, 126B at least partially define a channel 130 of the first bracket 122. The platform 128 includes a first surface 132 and a second surface 134. For instance, the first surface 132 of the platform 128 may be affixed to the second end 118 of the legs 114 of the support assembly 102.

In another non-limiting example, the second bracket 124 has two sidewalls 136A and 136B coupled together by (or integrally formed with) a platform 138. The platform 138 and the sidewalls 136A, 136B at least partially define a channel 140 of the second bracket 124. The platform 138 includes a first surface 142 and a second surface 144.

In embodiments, where the second bracket 124 is at an angle A approximately equal to 0 degrees relative to the first bracket 122, the sidewalls 126 of the first bracket 122 overlap with the sidewalls 136 of the second bracket 124. The second surface 134 of the platform 128 faces the first surface of the platform 138. As a result, the channels 130, 140 form a cavity 146 defined by the sidewalls 126, 136 and the platforms 128, 138 of the brackets 122, 124 respectively.

In embodiments, the first bracket 122 includes a first end 148 and a second end 150. The first end 148 includes one or more connecting apertures 152. For example, a connecting aperture 152 may be located on a sidewall 126 at the first end 148. The second end 150 of the first bracket 122 is opposite to the first end 148, and includes one or more pivot apertures 154. For example, a pivot aperture 154 may be located on a sidewall 126 at the second end 150.

In one non-limiting example, a first connecting aperture 152 is located in one sidewall 126 at the first end 148 of the first bracket 122, and a second connecting aperture 152 is located on the opposite sidewall 126 at the first end 148 of the first bracket 122. The connecting apertures 152 are coaxial apertures sharing an axis through the sidewalls 126, which are able to receive a fastener (e.g., a bolt, pin, or the like). In another non-limiting example, a first pivot aperture 154 is located in one sidewall 126 at the second end 150 of the first bracket 122, and a second pivot aperture 154 is located on the opposite sidewall 126 at the second end 150 of the first bracket 122. The pivot apertures 154 are coaxial apertures sharing an axis through the sidewalls 126, which are able to receive a fastener (e.g., a bolt, pin, or the like).

In embodiments, the second bracket 124 includes a first end 156 and a second end 158. The first end 156 includes one or more connecting apertures 160. For example, a connecting aperture 160 may be located on a sidewall 136 at the first end 156. The second end 158 of the second bracket 124 is opposite to the first end 156, and includes one or more pivot apertures 162. For example, a pivot aperture 162 may be located on a sidewall 136 at the second end 158.

In one non-limiting example, a first connecting aperture 160 is located in one sidewall 136 at the first end 156 of the second bracket 124, and a second connecting aperture 160 is located on the opposite sidewall 136 at the first end 156 of the second bracket 124. The connecting apertures 160 are coaxial apertures sharing an axis through the sidewalls 136, which are able to receive a fastener 161 (e.g., a bolt, pin, or the like). In another non-limiting example, a first pivot aperture 162 is located in one sidewall 136 at the second end 158 of the second bracket 124, and a second pivot aperture 162 is located on the opposite sidewall 136 at the second end 158 of the second bracket 124. The pivot apertures 162 are coaxial apertures sharing an axis through the sidewalls 136, which are able to receive a fastener 163 (e.g., a bolt, pin, or the like).

In embodiments, the locations of the connecting apertures 160 of the second bracket 124 correspond to the connecting apertures 152 of the first bracket 122. In addition, the locations of the pivot apertures 162 of the second bracket 124 correspond to the pivot apertures 154 of the first bracket 122.

For example, a fastener through the pivot apertures 154, 162 of the first and second brackets 122, 124 allows the second bracket 124 to pivot relative to the first bracket 122. It should be understood that the present disclosure is not limited to a fastener that passes through multiple pivot apertures 154, 162 of each of the first and second brackets 122, 124, where the multiple pivot apertures 154, 162 are coaxial through the width of the mounting device 100. For example, the fastener may pass through only a single pivot aperture 154, 162 of the brackets 122, 124, such as where a nut or other interlocking component is affixed to an interior surface of a sidewall 126 of the first bracket 122 within the channel 130 proximate to the pivot aperture 154. It is further noted that there may be multiple nuts affixed to the channel 130 proximate to respective pivot apertures 154.

By way of another example, a fastener 161 through the connecting apertures 152, 160 of the first and second brackets 122, 124 prevents the second bracket 124 from pivoting relative to the first bracket 122, instead securing the second bracket 124 to the first bracket 122. It should be understood that the present disclosure is not limited to a fastener that passes through multiple connecting apertures 152, 160 of each of the first and second brackets 122, 124, where the multiple connecting apertures 152, 160 are coaxial through the width of the mounting device 100. For example, the fastener may pass through only a single connecting aperture 152, 160 of the brackets 122, 124, such as where a nut or other interlocking component is affixed to an interior surface of a sidewall 126 of the first bracket 122 within the channel 130 proximate to the connecting aperture 152. It is further noted that there may be multiple nuts affixed to the channel 130 proximate to respective connecting apertures 152.

In embodiments, the one or more sidewalls 126 optionally includes at least one support member aperture 164. For example, the at least one support member aperture 164 may be positioned in the sidewall 126 between the apertures 152, 154. In embodiments, the one or more sidewalls 136 optionally includes at least one support member aperture 166. For example, the at least one support member aperture 166 may be positioned in the sidewall 136 between the apertures 160, 162.

In embodiments, the one or more sidewalls 136 optionally includes at least one pitch aperture 168. For example, the at least one pitch aperture 168 may be positioned in the sidewall 136 between the apertures 160, 166. The one or more pitch apertures 168 includes 2, 3 . . . up to an N number of apertures, with all of the pitch apertures 168 being arranged on the same sidewall 136.

In embodiments, the mounting device 100 includes an optional support member 170. It is noted that the support member 170 may be considered a component of, or a standalone component coupled to, the bracket assembly 120. In addition, it is noted that the support member 170 may increase the strength of the mounting device 100.

The support member 170 may be a linkage, a rod, a beam, or other three-dimensional member that is able to couple to the first bracket 122 and the second bracket 124. The support member 170 may be fabricated with any known three-dimensional volume such as, but not limited to, a plate having a reduced thickness, a rectangular prism, a cylinder, a triangular prism, and the like with any known axial cross-section (e.g., rectangle, circle, and the like) without departing from the scope of the present disclosure.

To secure the support member 170 to the bracket assembly 120, a first fastener engages the support member 170 and the support member apertures 164 of the first bracket 122 to couple the support member 170 within the channel 130 of the first bracket 122 at an angle B. For example, the angle B may range from approximately 0 degrees to approximately 180 degrees. In some instances, the angle B may range from approximately 0 degrees to approximately 90 degrees. It is noted that the angle B may be dependent on one or more preset angles that define roof pitches, as described in detail further herein.

A second fastener engages the support member 170 and either the support member aperture 166 or a particular pitch aperture 168 to couple the support member 170 within the channel 140 of the second bracket 124 at an angle C. For example, the angle C may range from approximately 0 degrees to approximately 180 degrees. In some instances, the angle C may range from approximately 0 degrees to approximately 90 degrees. It is noted that the angle C may be dependent on one or more preset angles that define roof pitches, as described in detail further herein.

The support member 170 may be positionable in one or more configurations relative to the first bracket 122 and the second bracket 124, depending on the particular configuration of the mounting device 100 in which the mounting device 100 is assembled.

For example, the support member 170 may be pivotable with respect to the first bracket 122 via the first fastener, to allow for the support member 170 to couple to either the support member aperture 166 or a particular pitch aperture 168. For instance, the support member aperture 166 and the one or more pitch apertures 168 of the second bracket 124 are each spaced along the length of the second bracket 124 to create a specific angle A between the first bracket 122 and the second bracket 124 when. As illustrated in FIG. 1B, the angle A may be set at substantially 90° when the second fastener secures the support member 170 to the support member apertures 166 in the second bracket 124. As illustrated in FIGS. 1C and 1D, the second bracket 124 may include a plurality of pitch apertures 168, where each correspond to a different pitch angle for a roof surface. For instance, pitch apertures 168A, 168B, 168C, 168D, 168E, 168F may be respectively set for a 2/12, 4/12, 6/12, 8/12, 10/12, or 12/12 roof pitch, each with a known and particular angle A between the first bracket 122 and the second bracket 124. It is noted that the second bracket 124 may have a visible mark marking the corresponding pitch angle or roof pitch for at least some of the pitch apertures 168.

It is noted, however, that the angle A is not limited to the abovementioned common pitch angles. For example, the mounting device 100 may be installed on a roof with a 1/12 pitch angle engaging the connecting aperture 152 (or more, generally, when inserted between the first bracket 122 and the second bracket 124 to angle the second bracket 124 relative to the first bracket 122). Alternatively, the support member 170 may be housed within the cavity 146 of the bracket assembly 120, and a spacing rod may be placed between the first bracket 122 and the second bracket 124 to separate the brackets 122, 124 and keep the second bracket 124 maintaining the approximately 4.76 degrees with the first bracket 122 and the installation surface. It is noted that the substantially horizontal configuration with the approximately 0-degree angle may be sufficient for the flat roof structure having a 1/12 pitch angle, without modification of the angle A between the first bracket 122 and the second bracket 124, without departing from the scope of the present disclosure.

In addition, it should be understood that the pitch apertures 168 may be set within the second bracket 124 for any angle A between the first bracket 122 and the second bracket 124, without departing from the scope of the present disclosure. In addition, it should be understood that the pitch apertures 168 may be elongated slots within the sidewalls 136 to allow for custom angles during installation, as compared to pre-defined angles formed as the apertures 168 during manufacturing, without departing from the scope of the present disclosure.

As aforementioned, the second bracket 124 includes one or more pitch apertures 168. The support member 170 further has a first end 172 and a second end 174. When the mounting device 100 is installed on a roof, the first end 172 of the support member 170 is connected to the first bracket 122 by fastening through the support member aperture 164, and the second end 174 of the support member 170 is connected to the second bracket 124 by fastening through the particular pitch aperture 168. For instance, the particular pitch aperture 168 is selected to support and secure the second bracket 124, maintaining an angle A between the first bracket 122 and the second bracket 124 that is substantially equal to the pitch angle of the roof while also maintaining a substantially parallel relationship between the platform 138 of the second bracket 124 and the ground.

By way of another example, the support member 170 may be pivotable to store within the channel 140 of the first bracket 122 when not in use (e.g., when the mounting device 100 is in the ground mount configuration). For instance, as illustrated in FIG. 1A, when the mounting device 100 is in a ground mount configuration, the support member 170 is housed within the cavity 146 to prevent a misplacing of the support member 170. It is contemplated, however, that the support member 170 may be fully removed from the cavity 146 when the mounting device 100 is in the ground mount configuration, without departing from the scope of the present disclosure.

When the optional support member 170 is not in use (e.g., when the mounting device 100 is in the ground mount configuration with angle A substantially equal to 0°), the fastener 161 that is used to secure the support member 170 may be removed from the apertures 166, 168 and instead be inserted into the connecting apertures 152, 160. In this regard, the same single (or multiple fasteners) may be used to prevent pivoting of the second bracket 124 relative to the first bracket 122 when in the ground mount configuration, and also may be used to set the angle A for the wall mount configuration with the support member apertures 166 or the roof mount configuration with the pitch apertures 168. This reduces the total number of components necessary for the mounting device 100, thus reducing manufacturing costs and product weight.

In embodiments, the second bracket 124 includes one or more standoff apertures 176 in the platform 138. The one or more standoff apertures 176 are able to receive one or more standoffs 178. For example, the one or more standoff apertures 176 may be elongated slots to allow for custom positioning of the standoffs 178 during installation. By way of another example, the one or more standoff apertures 176 may be substantially circular openings formed during manufacturing as pre-defined positions within the platform 138. In some instances, there are two standoff apertures 176 per mounting device 100, to couple to two of four feet on an exterior fixture.

In a non-limiting example, the standoffs 178 are constructed with cylindrical shapes with a diameter smaller or equal to the width of the second bracket 124. The standoffs 178 may include a bushing or other spacer that receives a fastener in a bore aligned with a longitudinal axis through the spacer, to secure the standoff 178 to both the second bracket 124 and the exterior fixture. It is appreciated that in other embodiments, however, the standoffs 178 may be constructed in any known three-dimensional volume such as, but not limited to, a rectangular prism, a cylinder, a triangular prism, and the like with any known axial cross-section (e.g., rectangle, circle, and the like) without departing from the scope of the present disclosure.

As illustrated in FIG. 1A, the one or more standoffs 178 may be attached to the second surface 144 of the platform 138 of the second bracket 124. For instance, the standoffs 178 may be positioned on the second surface 144 when the mounting device 100 is in the ground mount configurations, with the optional support member 170 being housed within the cavity 146 of the bracket assembly 120 (or removed from the mounting device 100).

As illustrated in FIG. 1B, the one or more standoffs 178 may be attached to the first surface 142 of the platform 138 of the second bracket 124. For instance, the standoffs 178 may be positioned on the first surface 142 when the mounting device 100 is in the wall mount configuration. The mounting device 100 is able to be installed on a wall with the second bracket 124 substantially vertical to the wall. Optionally, the support member 170 is connected between the first bracket 122 and the second bracket 124, pulling the second bracket 124 and keeping the second bracket 124 maintaining the approximately 90 degrees with the first bracket 122 and the installation surface (i.e., the substantially vertical exterior wall of a structure).

As illustrated in FIG. 1C-1D, the one or more standoffs 178 may be attached to the second surface 144 of the platform 138 of the second bracket 124. The mounting device 100 is able to be installed on roof surface having a particular pitch. For instance, the first bracket 122 may be substantially parallel to the roof surface and inclined from the ground surface with the pitch angle of the roof, and the second bracket 124 may be substantially parallel with the ground surface and inclined relative to the roof surface.

Referring specifically to FIG. 1C, FIG. 1C illustrates the mounting device 100 configured to installation on a roof with a 1/12 pitch angle, with a pitch setting 180 for the 1/12 pitch angle. The mounting device 100 may optionally include affixing apertures 182 (e.g., in one or more of the first bracket 122 and/or the second bracket 124), which are configured to receive a fastener to secure the mounting device 100 in the 1/12 pitch angle configuration.

Referring specifically to FIG. 1D, FIG. 1D illustrates the mounting device 100 installed on a roof with a pitch angle 12/12. Specifically, the support member 170 has the first end 172 fastened to the support member aperture 164 of the first bracket 122 and the second end 174 fastened to the 12/12 pitch aperture 168F of the second bracket 124. Consequently, the support member 170 sustains partial load of the device supporting and maintaining the second bracket 124 spaced from the first bracket 122 at an angle of approximately 45 degrees, to have the second bracket 124 be substantially parallel to the installation surface.

In this regard, the mounting device 100 is fully configurable for installation of the exterior fixture in any of a ground mount, wall mount, or roof mount configuration. In addition, the configuring may occur during installation, without need for additional or specific components for each configuration beyond the components provided with the mounting device 100 when assembled by a manufacturer and/or acquired by an installer.

Although embodiments of the present disclosure are directed to a support member 170 coupled to the first bracket 122 and the second bracket 124 via fasteners in pre-defined apertures 164, 166, 168, it is appreciated that in some embodiments the support member 170 may be angle iron or other bracket having any pre-determined or selected angle from 0 degrees to 180 degrees. For example, the angle iron may be positioned on or between the first bracket 122 and the second bracket 124, and may set the second bracket 124 at a particular angle A relative to the first bracket 122.

FIGS. 2A-2D in general illustrate views of the mounting device 100, in accordance with one or more embodiments of the present disclosure. Specifically, FIG. 2A illustrates a side view of the mounting device 100, FIG. 2B illustrates an end view of the mounting device 100 and FIGS. 2C and 2D illustrate a top view of the mounting device 100.

In a non-limiting embodiment, the mounting device 100 has two feet 108A and 108B from each other along a lateral axis, with two legs 114A and 114B attached to the two feet 108A and 108B respectively. A bracket assembly 120 is attached to the two legs 114 and placed above the two legs 114 vertically. Furthermore, the bracket assembly 120 has a first end 200 and a second end 202, where the first end 200 is proximate to the first leg 114A and the second end 202 is proximate to the second leg 114B. As shown in FIG. 2A, the length of the bracket assembly L extending in the lateral direction is approximate equal or longer than the maximum distance D2 between the two legs in the lateral direction.

The bracket assembly 120 includes at least two brackets. In the non-limiting embodiment, the first bracket 122 is affixed to the legs 114A and 114B. The second end 158 of the second bracket 124 is rotatably joined to the second end 150 of the first bracket 122, and the first end 156 of the second bracket 124 is optionally attached to the second end 150 of the first bracket 122 to prevent rotation or pivoting. For instance, when the mounting assembly is being installed on in the ground mount configuration, as shown in FIGS. 1A, 2A, and 3A, the first end 156 of the second bracket 124 may be affixed to the first end 148 of the first bracket 122 through a fastener. However, where the mounting device 100 is installed on a substantially vertical wall of a structure, as shown in FIGS. 1B, 4B, and 4D, the first end 156 of the second bracket 124 is pivoted away from the first end 148 of the first bracket 122. Similarly, when the mounting device 100 is installed on a roof with an inclined installation surface, as shown in FIGS. 1C, 1D, and 4B, the first end 156 of the second bracket 124 is also pivoted away from the first end 148 of the first bracket 122. The different configurations of the mounting devices 100 for different installation conditions will be discussed in further detail herein.

As shown in FIG. 2A, the second bracket 124 includes one or more pitch apertures 168 positioned on one of the sidewalls 136. In the non-limiting embodiment, six pitch apertures 168 are fabricated in the sidewall 136, and the six pitch apertures 168 are aligned along a lateral axis and positioned proximate to the first end 156 of the second bracket 124. It is appreciated that in other embodiments, the second bracket 124 may have varied numbers of pitch apertures 168 located at various locations along the length of the bracket 124.

FIG. 2B provides an end view of the mounting device 100. In the non-limiting embodiment, the first bracket 122 and the second bracket 124 are fabricated with a U-Shape, where the two brackets 122 and 124 each has a pair of bracket connecting apertures 152, 160. The connecting apertures 152, 160 are coaxial. A bracket connecting fastener connects the two brackets by extending through the sidewalls of the first and second brackets and the cavity 146 defined by the bracket channels 130, 140. It is appreciated that in another embodiment, there may be one or more additional connecting fasteners installed to connect the two brackets 122, 124. In yet another embodiment, the bracket connecting fastener may only partially pass through the brackets 122, 124.

As shown in FIG. 2B, the second bracket 124 has a width W1 larger than a width W2 of the first bracket 122, and the channel 140 of the second bracket 124 is also wider than the channel 130 of the first bracket 122. As a result, when the angle A between the first and the second bracket is approximately zero degrees, the sidewalls 136 of the second bracket 124 at least partially cover the sidewalls 126 of the first bracket 122. It is appreciated that in other embodiments, the brackets may not have a sidewall, and in yet other embodiments, width W1 of the second bracket 124 may be equal or smaller than the width W2 of the first bracket 122.

FIGS. 2C and 2D illustrate a top view of the mounting device 100. In embodiments, the width W1 of the second bracket 124 may be less than a width W3 of the feet 108. In addition, the length L1 of the bracket assembly 120 is smaller than the distance L2 between the outer sides of the two feet 108 (e.g., the total length of the mounting device 100). In this regard, the feet 108 provide an increased footprint for the mounting device 100, to increase load distribution from the exterior fixture coupled to the mounting device 100 and to decrease the possibility of tip-over for the mounting device 100.

However, it is contemplated that the length L1 and length L2 may be substantially identical and/or the width W1 and width W3 may be substantially identical where the outer edges of the feet 108 are substantially flush with the outer edges of the bracket assembly 120, without departing from the scope of the present disclosure. In addition, it is contemplated that the length L2 may be less than the length L1 where the support assembly 102 is inset within an envelope defined by the bracket assembly 120 (e.g., when viewed from the top), without departing from the scope of the present disclosure.

The second bracket 124 includes one or more standoff apertures 176 for standoffs 178. For example, two standoffs 178 may be attached to the standoff apertures 176, and positioned on the second surface 144 of the platform 138 of the second bracket 124. In some instances, the first and second standoffs 178A and 178B are positioned along the lateral axis with a distance equal or smaller than the length of the bracket assembly L, with a maximum distance D3 and a minimum distance D4 between the standoff apertures 176A, 176B.

In embodiments, the standoffs 178 are constructed in a cylindrical shape with a diameter R equal or smaller than a width W1 of the second bracket 124. It is noted, however, that the size and shape of the standoffs may vary without departing from the scope of the present disclosure. For example, the standoffs 178 may have a first width or radius R than is less than or equal to W1 at a first height as defined from the platform 138 to which the standoffs 178 are coupled, and may have a second radius that is greater than W1 at a second height as defined from the platform 138. In this example, the standoffs 178 may fit within the channel 140 within the second bracket 124 with the first radius R1 at the first height from the platform 138, but may still have an increased footprint to support the exterior fixture when attached with the second radius R2 at the second height.

In one non-limiting example as illustrated in FIGS. 1A-1D and 2A-2D, the feet 108 may be approximately 6 inches long and have a width W3 of approximately 6 inches, and approximately 0.19 inches ( 3/16) thick. Apertures 106 may be spaced through the thickness of the feet 108 in an arrangement that may be approximately 5 inches by approximately 5 inches. The legs 114 may have a height H of approximately 3 inches, and be approximately 3 inches deep by approximately 2.63 inches (2⅝ inches) wide.

In the non-limiting example as illustrated in FIGS. 1A-1D and 2A-2D, the first bracket 122 may be approximately 24 inches long, have a width W2 of approximately 2.88 inches (2⅞ inches) wide, and approximately 1.56 inches (1 9/16 inches) tall. The second bracket 124 may have a length L1 of approximately 24 inches, have a width W1 of approximately 3.75 inches, and approximately 1.5 inches tall. Apertures 160, 162 may be spaced approximately 22.5 inches (22½ inches) apart along the length of the second bracket 124, with the apertures 160, 162 spaced 0.88 inches (⅞ inches) from the platform 138 of the second bracket 124. The total length or height (depending on installation configuration) L for the mounting device 100 (including the support assembly 102 and the bracket assembly 120) may be approximately 26.5 inches (26½ inches). In some configurations, L2 for the mounting device 100 (including the support assembly 102 and the bracket assembly 120) may similarly be approximately 26.5 inches (26½ inches).

In the non-limiting example as illustrated in FIGS. 1A-1D and 2A-2D, when the first bracket 122 and the second bracket 124 are at zero pitch, the bracket assembly 120 may be approximately 1.81 inches (1 13/16 inches) tall. The standoffs 178 are approximately 1.5 inches in width or diameter. When the standoffs 178 are mounted in the standoff apertures 176 and extend from the surface 144 of the second bracket 124, the standoffs 178 are approximately 1.5 inches tall from the surface 144. In addition, the total height of the mounting device 100 when the first bracket 122 and the second bracket 124 are at zero pitch, and the standoffs 178 are mounted on and extend from the surface 144 of the second bracket 124, is 6.56 inches (6 9/16 inches).

In the non-limiting example as illustrated in FIGS. 1A-1D and 2A-2D, the standoff aperture 176A may be approximately 0.88 inches (⅞ inch) from the first end 156 of the second bracket 124, and approximately 5.81 inches (5 13/16 inches) long. The standoff aperture 176B may be approximately 7.63 inches (7⅝ inches) from the standoff aperture 176A, and may be approximately 6.06 inches (6 1/16 inches) long. In this regard, the standoff aperture 176B may be approximately 3.63 (3⅝ inches) from the second end 158 of the second bracket 124. With the standoff apertures 176A, 176B, the spacing of the standoffs 178A, 178B may range between approximately 7.94 inches (7 15/16 inches) for D4 and approximately 19.19 inches (19 3/16 inches) for D3, to accommodate different footprints of exterior fixtures.

In the non-limiting example as illustrated in FIGS. 1A-1D and 2A-2D, when the support member 170 is coupled to the first bracket 122 and the second bracket 124 (e.g., to the aperture 168F) such that the mounting device 100 is at a 12/12 pitch, the distance from the feet 108 of the base 104 to the surface 144 may be approximately 4.19 inches (4 3/16 inches). However, when the first bracket 122 and the second bracket 124 is at a zero pitch, the total height of the mounting device 100 including the standoffs 178 may be approximately 6.56 inches (6 9/16 inches).

In the non-limiting example as illustrated in FIGS. 1A-1D and 2A-2D, the total extension of the second bracket 124 from an installation surface, when the second bracket 124 is at an approximately 90-degree angle from the first bracket 122 and the base 104, may be approximately 27.44 inches (27 7/16 inches).

However, it is noted that any dimensions illustrated in FIGS. 1A-1D and FIGS. 2A-2C are not intended to be limiting on the present disclosure, but are merely provided for illustrative purposes.

FIG. 3A-3C generally illustrates a mounting system 300 including two or more mounting devices 100, in accordance with one or more embodiments of the present disclosure. For example, the mounting system 300 may be installed on a substantially horizontal ground surface, a substantially horizontal surface of a roof of the structure, or the like.

In embodiments, the mounting system 300 has two mounting devices 100A and 100B. The mounting device 100A and 100B are each placed on a substantially horizontal installation surface proximate to a structure 303, with the mounting device 100A and 100B substantially parallel to each other. The mounting devices 100A, 100B each have the second bracket 124 at an angle A of approximately 0 degrees from the first bracket 122, so that the second bracket 124 is generally parallel to the first bracket 122. Each mounting device 100A, 100B includes standoffs 178 within standoff apertures 176 in a second surface 144 of a platform 138 of the second bracket 124.

FIGS. 3B and 3C in general illustrate the mounting system 300 installed on an installation surface 302 that is substantially horizontal (e.g., a concrete ground plat) with an exterior fixture 304A or 304B (e.g., an AC unit), on top of the mounting device 100A, 100B. The mounting devices 100A, 100B are secured to the installation surface 302. For example, a plurality of fasteners may be inserted through the securing apertures 106 of the feet 108 into the installation surface 302 to secure the mounting devices 100A, 100B. The mounting device 100A and 100B are placed proximately parallel to each other and spaced from each other from a distance approximately equal to a width or spacing between feet 306A, 306B of the exterior fixture 304, so that the feet 306, 306B align with (and engage with) the standoffs 178 and/or the standoff apertures 176 (e.g., where the feet 306A, 306B couple directly to the standoff apertures 176).

As shown in FIGS. 3B and 3C, the exterior fixture 304B is installed on the mounting system 300, where a main housing 308 of the exterior fixture 304B is spaced from the installation surface 302 at a height approximately equal to a height of a mounting devices 100A, 100B (e.g., with optional standoffs 178) and the feet 306 of the exterior fixture 304B. The height of the mounting device 100 is the distance measured from the installation surface 302 to a bottom edge of the main housing 308.

FIGS. 4A-4D in general illustrate a mounting system 400 including two or more mounting devices 100, in accordance with one or more embodiments of the present disclosure. For example, the mounting system 400 may be installed on a substantially vertical installation surface 402 (e.g., a wall surface of a structure 403, or the like. As shown in FIGS. 4B and 4D, the mounting system 400 allows the mounting devices 100A, 100B to support and hold the weight of an exterior fixture 404 above a ground surface (e.g., including optionally without contacting the ground surface). This system is especially useful when there is no solid ground surface to bear the weight of the exterior fixture 404, or when the ground is not sufficiently flat or smooth (e.g., substantially horizontal) for the installation. It should be understood that aspects of the embodiments directed to the mounting system 400 may read on and/or be interchangeable with embodiments directed to the mounting system 300, and vice versa, without departing from the scope of the present disclosure.

FIGS. 4A and 4B illustrate one embodiment of the mounting system 400. In this non-limiting embodiment, two mounting devices 100A and 100B are attached and secured to a substantially vertical surface, where the first brackets 122 of the mounting devices 100A, 100B are substantially parallel to the installation surface 402. The second brackets 124 are angled at an angle A that is substantially perpendicular to the installation surface 402 (e.g., approximately 90 degrees).

The two mounting devices 100A, 100B are installed at approximately the same height on the installation surface 402 and are parallel to each other. In the mounting system 300, each mounting devices 100 has a support member 170, where one end 174 of the support member 170 is connected to the support member aperture 166 of the second bracket 124 and another end 172 of the support member 170 is connected to the support member aperture 164 of the first bracket 122. The support member 170 is attached to the first bracket 122 and the second bracket 124 to prevent the second bracket 124 from dropping to an increased angle A (e.g., larger than approximately 90 degrees), which may result in the sliding of the exterior fixture 404 from the mounting system 400.

Each mounting device 100 herein further has two standoffs 178 installed on the second bracket 124, which contacting the first surface 142 of the platform 138 of the second bracket 124. The dimensions of the second bracket 124 and the standoffs 178 are designed to position the feet 406A, 406B of the exterior fixture 404 at a sufficient height so that the exterior fixture 404 clears a height of the optional sidewalls 136 of the second bracket 124 and can be secured to the standoffs 178 within the standoff apertures 176 while the mounting devices 100A, 100B is secured to the installation surface 402. It is contemplated that the second bracket 124 may have a platform 138 without sidewalls 136. In addition, it is contemplated that the height of the standoffs 178 may be adjustable to allow the second bracket 124 to receive different exterior fixtures 404.

As shown in FIG. 4B, where the exterior fixture 404 is installed on the mounting devices 100A, 100B by attaching the feet 406A, 406B of the exterior fixture 404 to the second brackets 124A, 124B of the mounting devices 100A, 100B. The bottom surface of the housing 408 of the exterior fixture 404 is at or above the edge of the sidewalls 136 of the second brackets 124A, 124B, and the bottom surface of the housing 408 is approximately parallel to a ground surface. In addition, the back surface of the housing 408 is approximately parallel to the first brackets 122A, 122B and to the installation surface 402 to which the first bracket 122A, 122B is attached. In the non-limiting embodiment, the standoffs are adjusted to a position to allow a front edge of the feet 406A, 406B to approximately align with the second end 150 of the second bracket 124 while the back surface of the exterior fixture 404 is spaced form the first bracket 122. The support member 170 is further configured to have one end 172 connecting to the first bracket 122 and the other end 174 connecting to the second bracket 124 while contacting the back surface of the exterior fixture 404. It is contemplated, however, that at least the second bracket 124 may be dimensioned to receive exterior fixtures 404 with smaller or larger housing 408, as illustrated in FIGS. 4B and 4D, such that the above relationships are only illustrative and not to be interpreted as limiting.

FIGS. 4C and 4D provides another embodiment of the mounting system 400. In the embodiment of FIGS. 4C and 4D includes a shelf 410 configured to assist in installation of the mounting devices 100A, 100B. In particular, the shelf 410 is secured to the installation surface 402 prior to installation of the mounting device 100A, 100B. The shelf 410 may be provided to ensure alignment of the mounting devices 100A, 100B during installation, and/or may operate as an additional support or hand to hold the mounting device 100A, 100B while fasteners are being installed within the apertures 106 of the bases 104 of the mounting devices 100A, 100B. When used as additional support, a single individual may install the mounting devices 100A, 100B without concern of alignment on the installation surface 402.

In some non-limiting example, the shelf 410 is fabricated as a plate 411 with multiple apertures 412 aligned on the plate along a lateral direction to receive fasteners, to secure the shelf 410 onto the installation surface 402 of the structure 403. The shelf 410 further has a channel 414 defined between an edge or tab 416 of the plate 411 and the installation surface 402. When installed to the installation surface 402, the feet 108 of the bases 104 of the mounting devices 100A, 100B are inserted into the channel 414, to secure the feet 108 between the tab 416 and the installation surface 402.

It is noted that the shelf 410 may be used instead of fasteners through a set of apertures 106 in the bases 104 of the mounting devices 100A, 100B that engage the shelf 410 during installation, such that the shelf 410 is a permanent component of the installation. However, it is contemplated that the fasteners may still be inserted into the shelf-engaging bases 104, either with the shelf 410 as a permanent installation or to allow the shelf 410 to be removed and re-used during in another installation, without departing from the scope of the present disclosure.

FIGS. 5A and 5B in general illustrate a mounting system 500 including two or more mounting devices 100, in accordance with one or more embodiments of the present disclosure. For example, the mounting system 400 may be installed on an inclined installation surface 502 (e.g., a roof surface having a particular pitch, a sloped ground or wall surface, or the like). It should be understood that aspects of the embodiments directed to the mounting systems 300, 400 may read on and/or be interchangeable with embodiments directed to the mounting system 500, and vice versa, without departing from the scope of the present disclosure.

In FIGS. 5A and 5B, the mounting devices 100A, 100B are coupled to an installation surface 502 of a structure 503. In some examples, the installation surface 502 is a roof surface having a pre-defined roof pitch. The first brackets 122A, 122B of the mounting devices 100A, 100B are substantially parallel to the installation surface 502. The second brackets 124A, 124B of the mounting devices 100A, 100B forms an angle A to the first brackets 122A, 122B to create a leveled surface for the installations of an exterior fixture 404 (e.g., as shown in FIG. 5B).

As shown in FIG. 5A, the second brackets 124A, 124B of the mounting devices 100A, 100B is pivoted away from the first brackets 122A, 122B with the outer surfaces 144A, 144B of the platforms 138A, 138B of the second brackets 124A, 124B facing upwards to receive the standoffs 178A, 178B within the standoff apertures 176A, 176B for the exterior fixture 504.

In the non-limiting embodiment, the support members 170A, 170B of the mounting devices 100A, 100B are placed with one end 172 attached to the support member aperture 164A, 164B of the first brackets 122A, 122b. In addition, the other opposite end 174 is connected to one of the one or more pitch apertures 168A, 168B. For example, the particular pitch aperture 168A, 168B is selected to have the exterior fixture 504 substantially level and optionally substantially parallel with a ground surface (not shown). Here, the pitch apertures 168A, 168B are fabricated for corresponding common pitch angles for the installation structure 503. As shown in FIG. 5B, one end 174 of the support member 170 is connected to one of the pitch apertures 168A, 168B, so that the angle A between the first bracket 122 and the second bracket 124 is approximately equal to the pitch angle of the installation surface 502, and the exterior fixture is installed on the second bracket 124 by connecting the feet 506A, 506B of the exterior fixture 504 to standoffs 178A, 178B. As a result, the bottom surface of the housing 508 forms an angle A with the first brackets 122A, 122B and the installation surface 502 approximately equal to the pitch angle.

It is noted that in some embodiments, however, angle iron or other bracket may be provided without using a support member 170. Alternatively or in addition, the second brackets 124A, 124B may include steps or other structures to achieve different angles A without using pitch apertures 168A, 168B. Further, there may be infinite angles that can be achieved by the mounting devices 100A, 100B (e.g., where the pitch apertures 168A, 168B are elongated slots within the sidewalls 136 of the second bracket 124A, 124B and/or where the support member apertures 164A, 164B are elongated slots within the sidewalls 126A, 126B of the first bracket 122.

Although not shown it should be understood that the mounting device 100 may be installed on a substantially horizontal and planar roof surface (i.e., a roof with a zero pitch, which may be substantially parallel to the substantially horizontal and planar ground surface), without departing from the scope of the present disclosure. For example, the mounting device 100 may be installed in the ground mount configuration of FIG. 1A and FIGS. 3A-3B, but on a roof surface that is also substantially horizontal and planar.

Although not shown, it should be understood that the shelf 410 may be usable (or be a component of) the mounting system 500, without departing from the scope of the present disclosure. For example, the shelf 410 may similarly be usable to position and hold a pair of bases 104 from the mounting devices 100A, 100B to the installation surface 502 to prevent the mounting devices 100A,100B from sliding down the incline or pitch of the installation surface 502 during installation. Similarly, the shelf 410 may be usable with (or as a component of) the mounting system 300, without departing from the scope of the present disclosure.

In embodiments, the mounting device 100 (e.g., including any and/or all of the components of the mounting device 100) and/or any of the components of the mounting systems 300, 400, 500 may be fabricated from a metal, a plastic, or other material sufficiently rigid to support the weight of an installation while countering any wind or other weather conditions, without departing from the scope of the present disclosure.

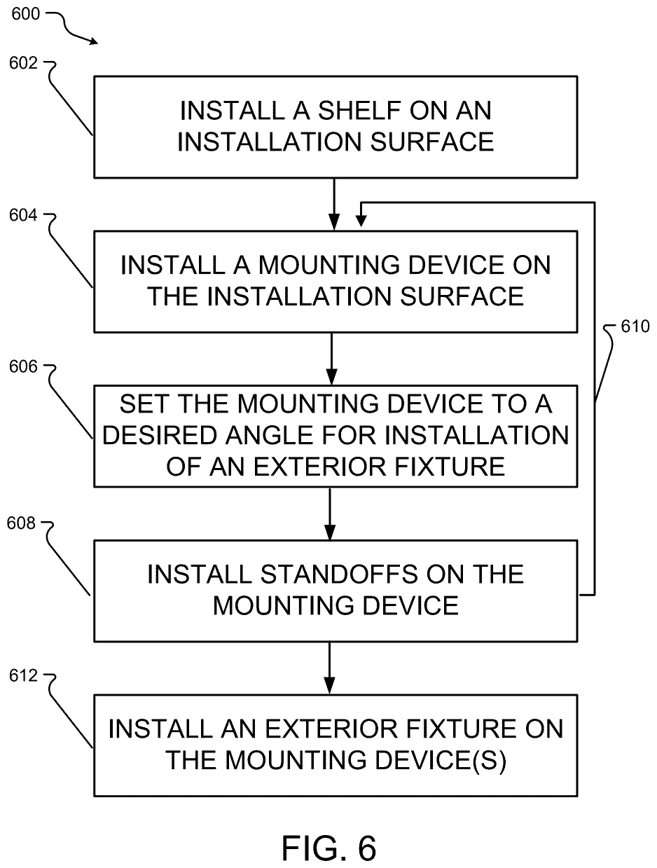

FIG. 6 is a method or process flow diagram 600 illustrating the operation of the mounting device 100 and systems 300, 400, 500 that include the mounting device 100, in accordance with one or more embodiments or the present disclosure. While a general order for the steps of the method or process is shown in FIG. 6, the method or process can include more or fewer steps or can arrange the order of the steps differently (including simultaneously, substantially simultaneously, or sequentially) than those shown in FIG. 6. It is noted that the method or process shall be explained with reference to the components, devices, subassemblies, environments, etc. described in conjunction with FIGS. 1A-5B. For example, it is noted that the embodiments as illustrated in FIGS. 1A-5B should be understood as reading on the embodiments described with respect to FIG. 6, and vice versa, without departing from the scope of the present disclosure.

In an optional embodiment, a shelf is coupled 602 to an installation surface. For example, the shelf 410 may be used where the installation surface 402 is a substantially vertical wall surface, to assist an installer by holding a mounting device 100 in place on an installation surface 402 and/or an installation surface 502 prior to the mounting device 100 being secured to the installation surface 402 and/or an installation surface 502.

In embodiments, a mounting device is installed 604 on the installation surface. The mounting device 100 may be positioned on an installation surface 302, the installation surface 402, or the installation surface 502. For example, a base 104 of the mounting device 100 may be inserted within the shelf 410 optionally installed on the installation surface 402 and/or the installation surface 502. Fasteners or other securing components may optionally be inserted within apertures 106 in the foot 108 of the base 104, to couple the base 104 to the installation surface, a where a bracket assembly 120 is coupled to the base 104.

In embodiments, the mounting device is set 606 at a pre-determined or selected angle for installation of the exterior fixture. For example, the mounting device 100 may be in a default configuration for a substantially horizontal mount configuration, with an angle A of approximately 0 degrees between a first bracket 122 and a second bracket 124 of the bracket assembly 120. By way of another example, the second bracket 124 may be pivoted relative to the first bracket 122, to set the second bracket 124 at a non-zero angle A relative to the first bracket 122.

For instance, the angle A may be approximately 90 degrees for a substantially vertical mount configuration. The optional support member 170 may engage a support member aperture 164 on the first bracket 122 and a support member aperture 166 on the second bracket 124.

In addition, the angle A may be between approximately 0 degrees and approximately 90 degrees for an inclined mount configuration. The optional support member 170 may engage a support member aperture 164 on the first bracket 122 and a pitch aperture 168 on the second bracket 124.

In general, the pre-determined or selected angle may be such that the exterior fixture is positioned in an orientation that is substantially level and optionally substantially parallel with a ground surface surrounding the structure to which the exterior fixture is coupled.

In embodiments, standoffs are optionally installed 608 on the mounting device. The standoffs 178 may be installed on a second surface 144 of the platform 138 of the second bracket 124 when the mounting device 100 is in the substantially horizontal or inclined mount configuration. Alternatively, the standoffs 178 may be installed on a first surface 142 of the platform 138 of the second bracket 124 when the mounting device 100 is in the substantially vertical mount configuration.

In embodiments, additional mounting devices are installed 610. For example, an exterior fixture may require 2, 3, . . . up to an N number of mounting devices, which are installed via one or more of operations 604, 606, 608. It is noted that the additional mounting devices may be installed in any order, such that each could be installed sequentially to completion or each could be installed in parallel (e.g., performing operations 604 together, etc.).

In embodiments, an exterior fixture is optionally installed 612 on the mounting devices. The exterior fixture is coupled to the second bracket 124, including via the optional standoffs 178 when installed.

In this regard, advantages of the present disclosure include, but are not limited to, a mounting device for an exterior fixture (e.g., such as an air conditioning unit, or the like). The mounting device is able to be set up in a plurality of configurations without needing to modify (e.g., add or remove components) the mounting device as assembled, where each configuration can be installed on a ground surface (e.g., a concrete surface located proximal to an exterior of a structure), on a wall surface of the structure, or on a roof of the structure respectively. Embodiments of the present disclosure are directed to multiple mounting devices being used in a system, and additionally are directed to a method for installation of the mounting device (or multiple mounting devices in the system).

Advantages of the present disclosure also include, but are not limited to, the mounting device including a support assembly and a bracket assembly. The support assembly includes one or more bases, each with a foot and a leg. The bracket assembly includes a first bracket that is coupled to the support assembly, and a second bracket that is pivotable with respect to the first bracket. The mounting device is adjustable for a plurality of configurations, including a substantially horizontal configuration (e.g., for substantially horizontal ground surfaces or roof surfaces of a structure, etc.), a substantially vertical configuration (e.g., for wall surfaces of the structure), and/or an inclined configuration (e.g., for inclined roof surfaces of the structure, inclined ground surfaces, etc.). Embodiments of the present disclosure are directed to an optional support member for setting the pre-determined or selected angle, and/or standoffs to raise and secure the exterior fixture to the second bracket.

While various embodiments of the present disclosure have been described in detail, it is apparent that modifications and alterations of those embodiments will occur to those skilled in the art. However, it is to be understood that such modifications and alterations are within the scope and spirit of the present disclosure, as set forth in the following claims. Further, the disclosure described herein is capable of other embodiments and of being practiced or of being carried out in various ways. It is to be understood that the phraseology and terminology used herein is for the purpose of description and should not be regarded as limiting.

A number of variations and modifications of the disclosure can be used. It would be possible to provide for some features of the disclosure without providing others. The present disclosure, in various embodiments, configurations, or aspects, includes components, methods, processes, systems and/or apparatus substantially as depicted and described herein, including various embodiments, configurations, aspects, subcombinations, and subsets thereof. Those of skill in the art will understand how to make and use the present disclosure after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and\or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A mounting device for an exterior fixture, comprising:
a support assembly; and
a bracket assembly comprising a first bracket and a second bracket, wherein the first bracket is coupled to the support assembly and the second bracket is pivotable with respect to the first bracket to set a pre-determined angle between the first bracket and the second bracket,
wherein the mounting device is selectively adjustable between at least one configuration including a substantially horizontal configuration, a substantially vertical configuration, and an inclined configuration based on the pre-determined angle set between the first bracket and the second bracket during installation of the exterior fixture, and
wherein the mounting device is installable on an installation surface, and wherein the exterior fixture is coupled to the second bracket when the mounting device is in the selected configuration of the at least one configuration after installation of the mounting device on the installation surface.

2. The mounting device of claim 1, wherein the support assembly comprises at least one base including a foot coupled to a first end of a leg, wherein the first bracket is coupled to a second end the leg.

3. The mounting device of claim 1, further comprising:
at least one standoff couplable to a respective standoff aperture within a surface of a platform of the second bracket, wherein the exterior fixture is coupled to the mounting device via the at least one standoff.

4. The mounting device of claim 3, wherein the surface is an exterior surface of the platform of the second bracket when the mounting device is in the substantially horizontal configuration.

5. The mounting device of claim 3, wherein the surface is an interior surface of the platform of the second bracket when the mounting device is in the substantially vertical configuration.

6. The mounting device of claim 3, wherein the surface is an exterior surface of the platform of the second bracket when the mounting device is in the inclined configuration.

7. The mounting device of claim 1, further comprising:
a support bracket that couples to the first bracket and a second bracket, wherein the support bracket secures the first bracket and the second bracket at the pre-determined angle.

8. The mounting device of claim 7, wherein the support bracket is housed within a cavity defined between the first bracket and the second bracket when the mounting device is in the substantially horizontal configuration.

9. The mounting device of claim 8, wherein a fastener for the support bracket is inserted within connecting apertures of the first bracket and the second bracket to prevent the second bracket from pivoting relative to the first bracket when the mounting device is in the substantially horizontal configuration.

10. The mounting device of claim 7, wherein the support bracket engages a first support member aperture on the first bracket and a second support member aperture on the second bracket when the mounting device is in the substantially vertical configuration.

11. The mounting device of claim 7, wherein the support bracket engages a support member aperture on the first bracket and a pitch aperture on the second bracket when the mounting device is in the inclined configuration, wherein the pitch aperture is one of a plurality of pitch apertures, and wherein each pitch aperture of the plurality of pitch apertures corresponds to a particular roof pitch.

12. A mounting system for an exterior fixture, comprising:
at least one mounting device for the exterior fixture, the at least one mounting device comprising:
a support assembly; and
a bracket assembly comprising a first bracket and a second bracket, wherein the first bracket is coupled to the support assembly and the second bracket is pivotable with respect to the first bracket to set a pre-determined angle between the first bracket and the second bracket,
wherein the at least one mounting device is selectively adjustable between at least one configuration including a substantially horizontal configuration, a substantially vertical configuration, and an inclined configuration based on the pre-determined angle set between the first bracket and the second bracket during installation of the exterior fixture, and
wherein the at least one mounting device is installable on an installation surface, and wherein the exterior fixture is coupled to the second bracket when the at least one mounting device is in the selected configuration of the at least one configuration after installation of the at least one mounting device on the installation surface.

13. The mounting system of claim 12, further comprising:
at least one standoff couplable to a respective standoff aperture within a surface of a platform of the second bracket, wherein the exterior fixture is coupled to the at least one mounting device via the at least one standoff.

14. The mounting system of claim 12, the at least one mounting device further comprising:
a support bracket that couples to the first bracket and a second bracket, wherein the support bracket secures the first bracket and the second bracket at the pre-determined angle.

15. The mounting system of claim 12, further comprising:
a shelf installable on the installation surface prior to the installation of the at least one mounting device, wherein the at least one mounting device is able to engage the shelf during installation of the at least one mounting device.

16. A method for installing an exterior fixture, comprising:
installing a mounting device on an installation surface, the mounting device comprising:
a support assembly; and
a bracket assembly comprising a first bracket and a second bracket, wherein the first bracket is coupled to the support assembly and the second bracket is pivotable with respect to the first bracket to set an angle between the first bracket and the second bracket;
setting the mounting device to a pre-determined angle for installation of an exterior fixture, wherein the mounting device is selectively adjustable between at least one configuration including a substantially horizontal configuration, a substantially vertical configuration, and an inclined configuration based on the pre-determined angle set between the first bracket and the second bracket during installation of the exterior fixture; and
installing an exterior fixture on the mounting device, wherein the exterior fixture is coupled to the second bracket when the mounting device is in the selected configuration of the at least one configuration after installation of the mounting device on the installation surface.

17. The method of claim 16, further comprising:
installing at least one standoff on the mounting device prior to installation of the exterior fixture on the mounting device, wherein the exterior fixture is coupled to the mounting device via the at least one standoff.

18. The method of claim 16, further comprising:
installing a second mounting device on the installation surface, the second mounting device comprising:
a second support assembly; and
a second bracket assembly comprising a third bracket and a fourth bracket, wherein the third bracket is coupled to the second support assembly and the fourth bracket is pivotable with respect to the first bracket to set an angle between the third bracket and the fourth bracket;
setting the second mounting device to a second pre-determined angle for installation of the exterior fixture, wherein the second mounting device is selectively adjustable between at least one configuration including a substantially horizontal configuration, a substantially vertical configuration, and an inclined configuration based on the second pre-determined angle set between the third bracket and the fourth bracket during installation of the exterior fixture; and
installing the exterior fixture on the second mounting device, wherein the exterior fixture is coupled to the fourth bracket when the second mounting device is in the selected configuration of the at least one configuration after installation of the second mounting device on the installation surface.

19. The method of claim 18, further comprising:
installing at least one standoff on the second mounting device prior to installation of the exterior fixture on the mounting device, wherein the exterior fixture is coupled to the second mounting device via the at least one standoff.

20. The method of claim 16, further comprising:
installing a shelf on the installation surface prior to installing the mounting device, wherein the mounting device is able to engage the shelf during installation of the mounting device.
